(19) United States
(12) Patent Application Publication
(10) Pub. No.: US 2024/0190032 A1
(43) Pub. Date: Jun. 13, 2024

(54) CHAINSAW GUIDE BAR WITH ONBOARD CIRCUITRY

(71) Applicant: Oregon Tool, Inc., Portland, OR (US)

(72) Inventors: Andrew Otto, Portland, OR (US); Rob Torres, Portland, OR (US); Jon Ziring, Portland, OR (US); Sam Hutsell, Portland, OR (US); Jake R. Wade, Milwaukie, OR (US); Brian J. Oleson, Portland, OR (US)

(73) Assignee: Oregon Tool, Inc., Portland, OR (US)

(21) Appl. No.: 18/532,131

(22) Filed: Dec. 7, 2023

Related U.S. Application Data
(60) Provisional application No. 63/386,372, filed on Dec. 7, 2022.

(51) Int. Cl. B27B 17/02; B23D 59/00

(52) U.S. Cl. CPC B27B 17/025; B23D 59/001; B23Q 17/008

(57) ABSTRACT

A chain saw includes a guide bar. The guide bar includes a recess. A communication chip or other onboard circuitry is positioned in the recess of the guide bar.

### CROSS-REFERENCE TO RELATED APPLICATION

This application claims the benefit of and priority to U.S. Provisional Patent Application No. 63/386,372 filed Dec. 7, 2022, the entire disclosure of which is incorporated by reference herein in its entirety.

### BACKGROUND

The present disclosure relates generally to chainsaws, in particular to guide bars for chainsaws. In use, a guide bar is subjected to extensive, forceful contact with objects and materials (e.g., wood, plant matter, concrete, etc.) being cut by chainsaws, such that the guide bar will degrade over time. A user may eventually desire to replace the guide bar. However, by such time and as a result of wear on the guide bar, product identification information conventionally printed on the guide bar (e.g., product name, brand name, serial number, size information, etc.) could have worn off (e.g., been scrapped/scratched off during use of the guide bar). Without such information, a user may have difficulty identifying a proper replacement guide bar, thereby obstructing maintenance and continued use of the chain saw.

Additionally, it can be difficult to determine when to replace a guide bar or other component of a chain saw (e.g., cutting chain). Users of conventional guide bars lack information on chain saw performance and other conditions relating to such guide bars.

### SUMMARY

One implementation of the present disclosure is a chain saw including a guide bar. The guide bar includes a recess and a communication chip is positioned in the recess of the guide bar. The communication chip is configured to cause a reader device to display information relating to the guide bar.

Another implementation of the present disclosure is a guide bar. The guide bar includes a first layer comprising a recess, and a communication chip positioned in the recess. The communication chip is configured to store a message relating to the guide bar and transmit the message in response to induction of a current in the communication chip.

Another implementation of the present disclosure is a method of replacing a guide bar on a chain saw. The method includes obtaining an electronic message from a passive communication chip embedded in the guide bar by bringing a reader device into proximity with the passive communication chip, acquiring a replacement guide bar based on the electronic message, and installing the replacement guide bar on the chain saw.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a chainsaw having a guide bar with a communication chip, according to some embodiments.

FIG. 2 is a set of views of guide bars with communication chips, according to some embodiments.

FIG. 3A is a top, cut-away view of a communication chip installed in a guide bar, according to some embodiments.

FIG. 3B is another top, cut-away view of a communication chip installed in a guide bar, according to some embodiments.

FIG. 4A is yet another top, cut-away view of a communication chip installed in a guide bar, according to some embodiments.

FIG. 4B is yet another top, cut-away view of a communication chip installed in a guide bar, according to some embodiments.

FIG. 5 is a story-board style illustration of process involving a communication chip of a guide bar, according to some embodiments.

FIG. 6 is an image of chainsaw with a communication chip, according to some embodiments.

FIG. 7 is an illustration of a multi-piece guide bar with communication chips, according to some embodiments.

FIG. 8 includes additional illustrations of guide bar, according to some embodiments.

FIG. 9 is an illustration of a guide bar with onboard circuitry, according to some embodiments.

FIG. 10 is a block diagram of onboard circuitry of a guide bar, according to some embodiments.

FIG. 11 is a block diagram of a system including sensors onboard a guide bar, according to some embodiments.

### DETAILED DESCRIPTION

Referring generally to the figures, views of a guide bar including a communication chip, and a chainsaw including such a guide bar, are shown, according to various embodiments. As described in further detail below, the teachings herein relate to a guide bar including onboard circuitry, for example a communication chip, where the communication chip is configured to cause an external device (e.g., smartphone) to display product information relating to the guide bar, and/or processing and memory components configured to process data from at least one sensor on the guide bar. The onboard circuitry is installed in the guide bar in a manner which promotes continued availability of the onboard circuitry at the guide bar even after the guide bar has been heavily used and various markings, labels, etc. on the guide bar may have worn and rendered illegible. The teachings herein can thereby support maintenance and continued use of a chainsaw by providing user-friendly access to replacement part information, ordering systems, and other instructions, content, etc. supporting proper maintenance and use of guide bars and chainsaws and/or by providing insights based on measurement of conditions experienced by the guide bar.

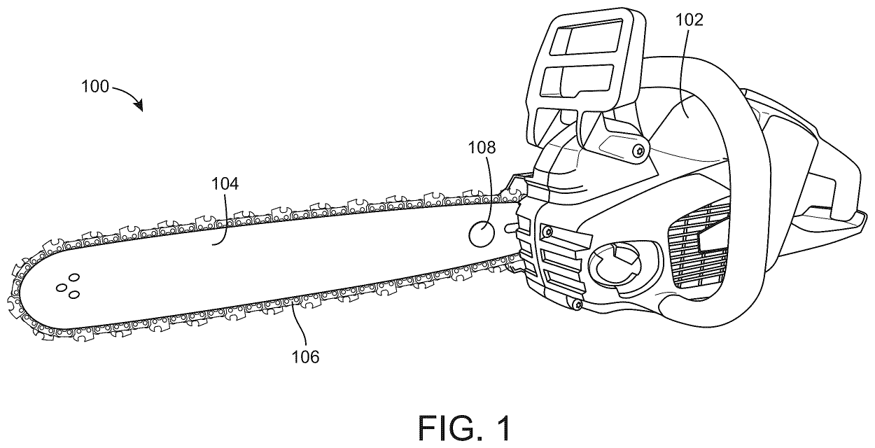

Referring now to FIG. 1, a chainsaw 100 is shown, according to some embodiments. The chainsaw 100 includes a body 102, a guide bar 104 coupled to the body and extending from the body 102, and a saw chain coupled to the guide bar 104 and extending along a periphery of the guide bar 104 (e.g., in a closed loop). The body 102 includes a motor (e.g., combustion engine, electric motor) operable to drive the saw chain 106 along the guide bar 104, such that the saw chain 106 rotates around the guide bar 104 during operation of the chainsaw 100.

The saw chain 106 includes cutting links, sharp portions, etc. such that, when driven to rotate around the guide bar 104, the saw chain can cut into, through, etc. external objects, materials etc. During execution of cuts using the chainsaw 100, some or all of the guide bar 104 will be disposed within an object being cut (e.g., a log, etc.) and as a result, the guide bar 104 will typically be scraped, scratched, scuffed, etc. by interaction with the object being cut.

The guide bar 104 and the saw chain 106 are detachable from the body 102 of the chainsaw 100. The guide bar 104 and the saw chain 106 can thus be selectively removed from the body 102 of the chain saw and replaced with new instances of the guide bar 104 and/or the saw chain 106. Because the guide bar 104 and the saw chain 106 experience significantly more wear than the body 102, the life of the chainsaw 100 can be significantly expanded by periodically removing and replacing the guide bar 104 and/or the saw chain 106 with a new guide bar and/or new saw chain (at the same time, on different schedules, etc.). The body 102 is compatible with a limited set of guide bar sizes, configurations, types, etc., such that successfully replacing the guide bar 104 and/or the saw chain 106 benefits from product information about the guide bar 104, for example a guide bar 104 as originally installed and sold by the manufacturer of the chain saw 106 and/or previously installed and/or used by a user of the chain saw 106.

The guide bar 104 preferably includes a communication chip 108. As shown in FIG. 1, the communication chip 108 has a position along the guide bar 104 such that the chip position is spaced apart from the body 102. In other embodiments, the communication chip 108 is positioned so as to be obstructed from external access by the body 102 when the guide bar 104 is attached to the body 102. The communication chip 108 is provided as onboard circuitry included with the guide bar 104.

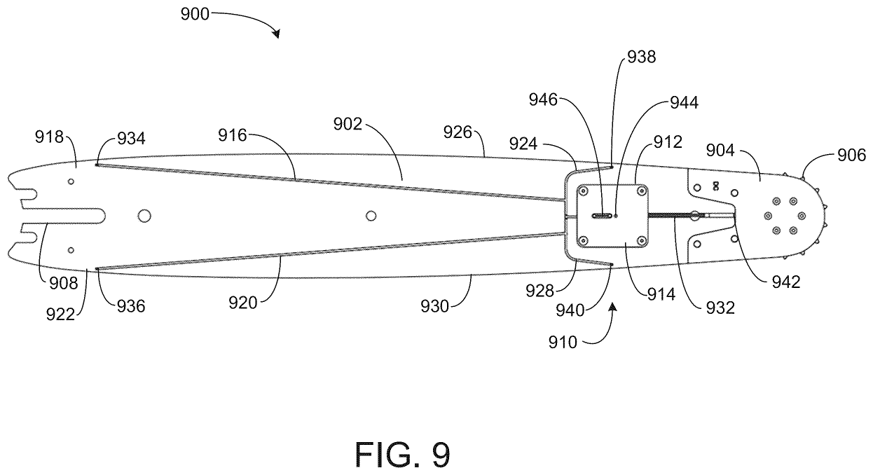

The communication chip 108 is configured to cause a compatible reader device (e.g., smartphone) to display product information relating to the guide bar 104. The communication chip 108 may be a passive communication chip, for example a near-field communication (NFC) tag including an antenna, which is powered inductively by the reader device when the reader device is brought into close proximity with the communication chip 108 (e.g., within two inches, within an inch, etc.). The communication chip 108 stores a message for communication to the reader device, and, when, powered by the reader device, wirelessly (e.g., using radio-frequency communications) provides the message to the reader device. As described in further detail below, the message can include product information about the guide bar 104 and/or an address to a webpage or other electronic/digital source of content relating to the guide bar 104, for example. In some embodiments, the communication chip 108 can also be provided as onboard circuitry configured to execute sensing, processing, memory, etc. functions, for example as described below with reference to FIGS. 9-11, in addition to or as an alternative to the communication functions attributed to the communication chip 108 in the description herein.

One aspect of the present disclosure is an experimental determination that the communication chip 108 (e.g., NFC tag) is able to withstand harsh environmental conditions expected to be experienced by the guide bar 104 during use and storage (including improper storage) of the chainsaw 100, while retaining an ability to store a message and communicate that message to a reader device when powered by said reader device. For example, the present disclosure includes an experimental determination that a communication chip within the scope of the present disclosure can withstand temperatures of up to 400 degrees Fahrenheit (e.g., an estimated temperature of the guide bar 104 during heavy use). Testing also showed that communication chips within the scope of the present disclosure can withstand being submerged in liquids (e.g., water, gas, liquid) and exposure to electric shocks and at least some magnetic fields. The present disclosure thus includes a determination that the communication chip 108 (e.g., NFC tag) can be installed in the guide bar 104 and remain functional throughout a typical lifecycle of the guide bar 104.

The communication chip 108 is shown in FIG. 1 as being positioned in a channel, hole, recess, window, etc. in the guide bar 104, for example advantageously enabling a clear path for electromagnetic signals between the communication chip 108 and a reader device (which may otherwise be obstructed due to conductive and/or magnetic properties of materials of the guide bar 104).

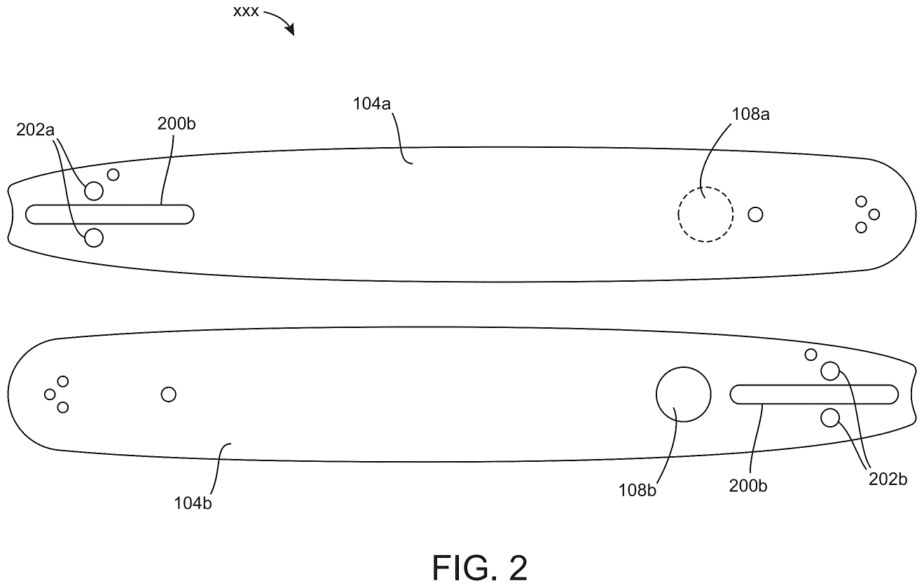

Referring now to FIG. 2, example embodiments of the guide bar 104 are shown, according to some embodiments. In particular, FIG. 2 shows a first guide bar 104a having a first communication chip 108a and a second guide bar 104b having a second communication chip 108b. The first guide bar 104a includes a slot 200a and holes 202a configured to facilitate coupling of the first guide bar 104a to the body 102 of the chainsaw 100. The second guide bar 104b includes a slot 200b and holes 202b configured to facilitate coupling of the second guide bar 104b to the body 102 of the chainsaw 100.

As shown in FIG. 2, the first communication chip 108a is spaced apart from the slot 200a and the holes 202a such that a majority of the length of the first guide bar 104a is between the first communication chip 108a and the slot 200a and the holes 202a. On the second guide bar 104b, the second communication chip 108b is positioned proximate the slot 200b such that a majority of the second guide bar 104b is not between the second communication chip 108b and the slot 200b. Various positions of communication chips spaced along the lengths of the guide bars are within the scope of the present disclosure.

As shown in FIG. 2, the first guide bar 104a and the second guide bar 104b include a coating (e.g., paint, silk screen, print, etc.). For example, the coating may have a silver or other metallic color. On the first guide bar 104a, the first communication chip 108a is covered by said coating, such that the first communication chip 108a visually blends in with a remainder of the first guide bar 104a. The first guide bar 104a may appear as continuously extending through the location of the first communication chip 108a. On the second guide bar 104b, the coating does not cover the second communication chip 108b, such that the second communication chip 108b (e.g., a surface, housing, covering, etc. thereof, in various embodiments) is visible on the second guide bar 104b. As shown for the second communication chip 108b, instructions in text form (e.g., “Scan Me,” “Scan Here,” “Place Device Here,” etc.) or icon form (e.g., commonly-used symbol for NFC-enabled devices) can be printed or otherwise visually presented on a guide bar 104 and/or on the communication chip 108 (e.g., on second communication chip 108b) instruct a user on how to initiate communication with a communication chip 108.

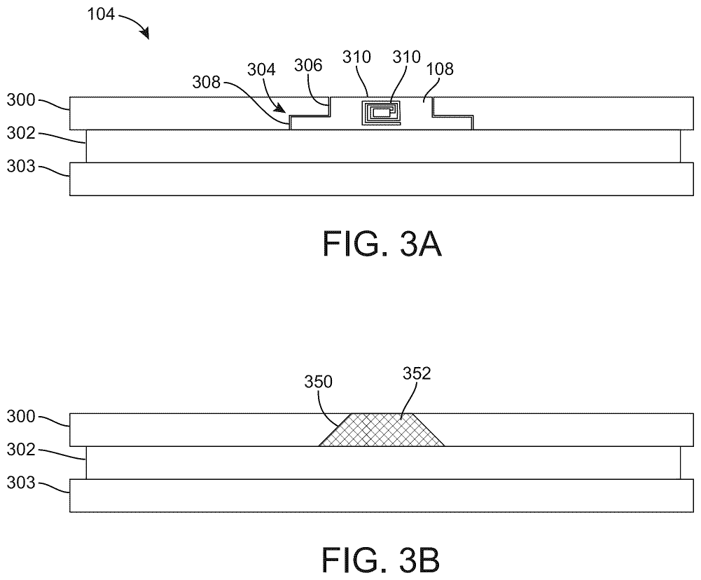

Referring now to FIG. 3A, a cut-away top view of the guide bar 104 is shown, according to some embodiments. The top view of the guide bar 104 looks at the narrow side of the guide bar 104, with a cut-away view shown at the level of the guide bar 104 including the communication chip 108. In the example shown, the guide bar 104 is a laminated guide bar, including at least a first layer 300 and a second layer 302 coupled together to form the guide bar 104. The guide bar 104 is further shown as including a third layer 303, with the third layer coupled to the first layer 300 and the second layer 302 with the second layer 302 between the first layer 300 and the third layer 303. The first layer 300, the second layer 302, and the third layer 303 may be made of steel, for example.

As shown in FIG. 3A, the first layer 300 includes a stepped recess 304 having a narrower portion 306 and a wider portion 308 (the narrower portion 306 being narrower than the wider portion 308). The communication chip 108 is positioned in the stepped recess 304 with the narrowest portion of the recess adjacent the exterior surface of the first layer 300. In particular, as shown, the communication chip 108 includes a stepped housing 310 substantially complementary to the negative space of the stepped recess 304 so as to fit snuggly in the stepped recess 304 with an external surface of the stepped housing 310 substantially flush with an external surface of first layer 300, and circuitry components 312 of the communication chip 108 included in the stepped housing 310. In some embodiments, the stepped recess 304 also extends into the second layer 302, such that the second layer 302 is recessed and the stepped housing 310 is partially disposed in both the first layer 300 and the second layer 302. The stepped housing 310 can be made of a material which allows electromagnetic communications therethrough (e.g., plastic). The stepped housing 310 may be a structure including an open inner volume in which the circuitry components 312 are contained or may substantially solid mass (e.g., puck) containing the circuitry components 312 (e.g., injection-molded with the circuitry components 312 therein).

During manufacturing, the stepped recess 304 can be formed (e.g., punched) in the first layer 300. The stepped housing 310 can be then be positioned in the stepped recess 304. The second layer 302 can then be coupled (e.g., laminated) to the first layer 300, thereby retaining the stepped housing 310 (and thus, the communication chip 108) in the guide bar 104. The stepped recess 304 provides a communication channel to/from the communication chip 108.

Referring now to FIG. 3B, another embodiment cut-away top view of the guide bar 104 is shown, according to some embodiments. As in FIG. 3A, the guide bar includes the 104 is a laminated guide bar, including at least a first layer 300 and a second layer 302 coupled together to form the guide bar 104. The guide bar 104 is further shown as including a third layer 303, with the third layer coupled to the first layer 300 and the second layer 302 with the second layer 302 between the first layer 300 and the third layer 303. The first layer 300, the second layer 302, and the third layer 303 may be made of steel, for example.

In FIG. 3B, a tapered recess 350 is provided in the first layer 300. A tapered housing 352 can then be positioned in the tapered recess 310, with the tapered housing 352 including the communication chip 108 and the tapered housing 352 substantially complementary in shape to the tapered recess 310. The tapered recess 350 is narrowest at an external surface of the first layer 300, widening as the tapered recess 350 gets deeper into the first layer 300 (e.g., such that the tapered recess 350 can be characterized as a countersunk recess 350). In a similar manner as described above for the embodiments of FIG. 3A, the tapered housing 352 is retained in the tapered recess 350 by the tapering (e.g., as an external opening of the tapered recess 350 is smaller than the tapered housing 352) and by the second layer 302. The communication chip 108 is illustrated in a manner suitable for the diagrams shown, and is contemplated to be oriented substantially in a plane parallel to the first layer 300, the second layer 302, and the third layer 303.

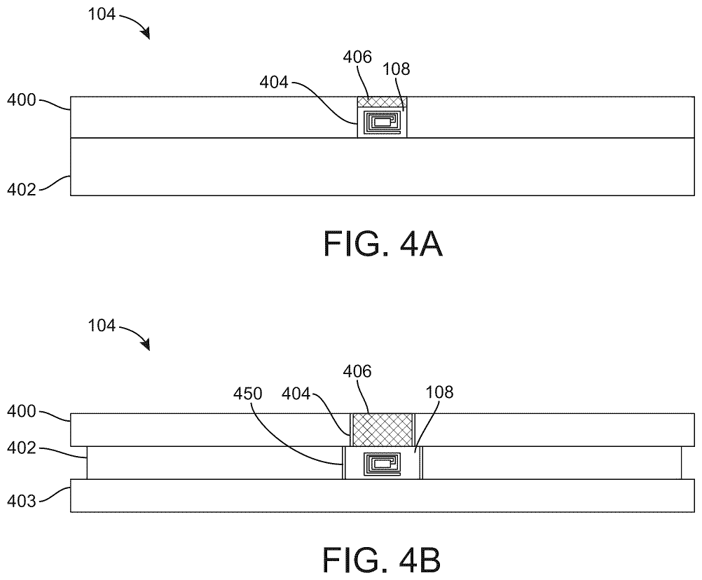

Referring now to FIG. 4A, another cut-away top view of the guide bar 104 is shown, according to some embodiments (e.g., different embodiments that FIG. 3A & 3B). As in FIG. 3A, the guide bar 104 includes a first layer 400 and a second layer 402 coupled to the first layer 400, for example laminated together. The first layer 400 and the second layer 402 may be made of steel, for example. The example of FIG. 4A may also include a third layer, consistent with FIGS. 3A-B as described above.

As shown in FIG. 4A, a hole (recess, channel, opening, etc.) 404 is included in the first layer 400 (e.g., punched in the first layer 400 during manufacturing). The communication chip 108 is positioned in the hole 404. Glue, adhesive, epoxy, etc. can be included to retain the communication chip 108 in the hole 404. Examples of suitable glue, adhesive and epoxy for various embodiments include 3M DP100, LOCTITE EA E-120HP, Resinlab EP1200, and Lord 201/4. FIG. 4A further shows a protective layer 406 positioned over the communication chip 108 to protect the communication chip 108 during use of the guide bar 104 and provide a flush, continuous surface along the external side of the first layer 400 across the hole 404 (e.g., to prevent objects from being caught in the hole during use of the guide bar). The protective layer 406 may be made of an adhesive, epoxy, etc., for example as described above, or may be a ceramic, polymer, composite, etc., in various embodiments.

In some embodiments, the first layer 400 and the second layer 402 are formed as a solid piece of steel (rather than separate layers later coupled together). In such an embodiments, the guide bar 104 may be referred to a solid guide bar. In such embodiments, the recess, opening, etc. 404 can be machined in the guide bar 104 to provide space for the communication chip 108 to be positioned in, embedded in, coupled to, etc. the guide bar 104 as shown in FIG. 4. A solid bar may also be provided with a recess adapted from the embodiments of FIGS. 3A-B, for example.

Referring to FIG. 4B, yet another cut-away top view of the guide bar 104 is shown, according to some embodiments. As shown in FIG. 4B, the guide bar 104 includes the first layer 400, the second layer 402, and a third layer 403 coupled to the second layer 402 such that the second layer 402 is between the first layer 400 and the third layer 403. As shown, the hole 404 in the first layer 400 is entirely filed with protective layer 406, i.e., with a material that allows wireless electronic communication therethrough (e.g., non-conductive and/or non-ferrous material). The second layer 402 is shown as including a recess 450 aligned with the hole 404 and the protective layer 406. The communication chip 108 is positioned in the recess 450, for example with the communication chip 108 formed as a puck (e.g., solid, injection-molded mass primarily of plastic, etc.) or housing containing the antenna, electronics, etc. of the communication chip 108. When the first layer 400 and the second layer 402 are coupled together (e.g., welded, laminated) as shown in FIG. 4B, the communication chip 108 is retained in the guide bar 104, for example by the protective layer 406 and/or by the relative sizes of the communication chip 108 and the hole 404 in the first layer 400. FIG. 4B thereby illustrates that the communication chip 108 can be provided in a middle layer of a laminated guide bar, with a window (shown as hole 404) in one or more surrounding, external layers which enables wireless communication to and from the communication chip 108.

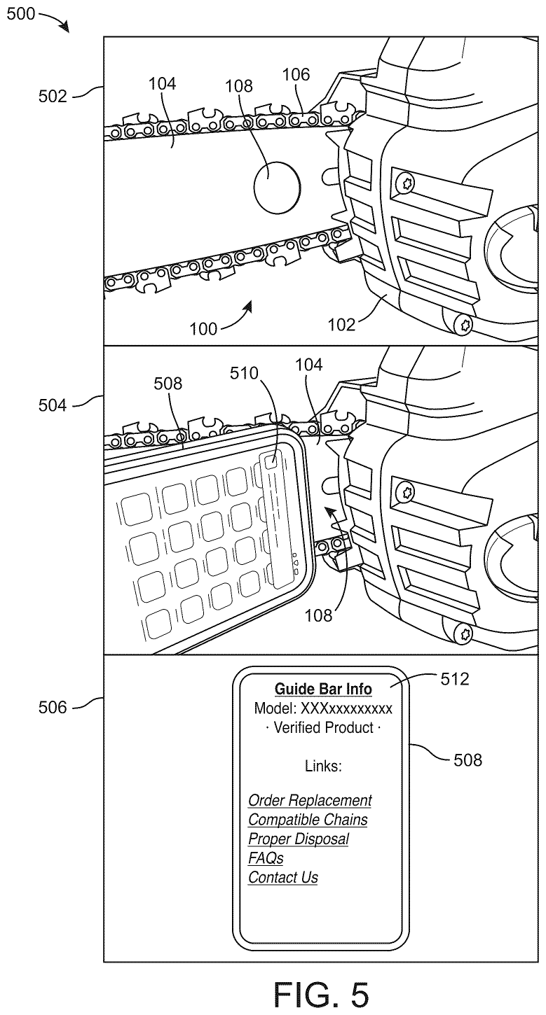

Referring now to FIG. 5, a storyboard-style illustration 500 of a process of using the communication chip 108 to access information relating to the guide bar 104 is shown, according to some embodiments. The storyboard-style illustration 500 includes a first frame 502, a second frame 504, and a third frame 506.

The first frame 502 shows a portion of the chainsaw 100, including the body 102, the guide bar 104, the saw chain 106, and the communication chip 108. In the first frame 502, a user may locate the communication chip 108, for example based on text or symbol printed on the guide bar 104 (e.g., on the communication chip 108) (e.g., “Scan Here”), based on color differentiation of a region including the communication chip 108, etc. The communication chip 108 is passive, unpowered, not communicating, etc. in the first frame 502.

The second frame 504 shows a reader device (shown as smartphone 508) brought into close proximity to the communication chip 108 (e.g., touching a surface of the communication chip 108/guide bar 104, within one inch, within two inches, etc.). As shown in the second frame 504, the smartphone 508 emit an electromagnetic signal which induces current in the communication chip 108, thereby powering the communication chip 108 and causing the communication chip 108 to send a message to the smartphone 508. In some embodiments, the smartphone 508 constantly emits such a signal and searches for responsive messages. In other embodiments, the user may interact with the smartphone 508 to request that the smartphone initiate power transfer and communications with the communication chip 108.

In the second frame 504, a message is received at the smartphone 508 from the communication chip 108. A notification 510 displays on the smartphone 508 indicating to a user that the message has been received. The notification 510 is selectable by the user to advance to the third frame 506.

The third frame 506 shows the smartphone 508 presenting a graphical user interface 512 caused to be presented on the smartphone 508 by the message from the communication chip 108. In some embodiments, the graphical user interface 512 includes text, image, documents, stored on the communication chip 108 and provided directly to the smartphone 508, such that the content displayed in the graphical user interface 512 is stored, programmed, etc. onto the communication chip 108 (e.g., during manufacturing of the guide bar 104).

In some embodiments, the graphical user interface 512 is provided as a website (e.g., accessible via the Internet) and the communication chip 108 provides an internet address (e.g., URL) to the smartphone 508 to cause the smartphone 508 to access the website and display the graphical user interface 512. In such embodiments, the internet address is stored, programmed, etc. onto the communication chip 108 (e.g., at the time of manufacturing of the guide bar 104) and the webpage is hosted remotely (e.g., on a server associated with a seller or manufacturing of the guide bar 104) such that the content of the graphical user interface 512 can be updated after sale of the guide bar 104 to provide up-to-date information. In some embodiments, the smartphone 508 provides a mobile application relating to chainsaws, guide bars, forestry, etc. (e.g., a mobile app offered by a seller or manufacturing of the guide bar 104), and the communication chip 108 provides a code, instruction, command, etc. for the mobile application which causes the mobile application to display the graphical user interface. The mobile application can be updated over time to enable display of up-to-date information.

As shown in FIG. 5, the graphical user interface 512 displays product information such as a model number of the guide bar 104. Product information relating to the guide bar 104 and displayed by the graphical user interface 512 can additionally or alternatively include a model name, a serial number, a product size, a brand name, a product manufacturing date, manufacturing location, product lot number, etc.

The graphical user interface 512 is also shown as indicating that the guide bar 104 is a verified product (e.g., not a counterfeit product). In some embodiments, the communication chip 108 may provide a security code (e.g., passcode, password) or token to the smartphone 508, which can exchange such code, token, etc. with a server hosting the graphical user interface 512. In such embodiments, the server is configured to verify that the code, token, etc. matches an expectation for guide bars manufactured by an authorized manufacturing (e.g., non-counterfeit guide bars), and cause an indication of such verification to be displayed in the graphical user interface. Such an indication reassures the user that the guide bar 104 is authentic and has the performance advantages expected for authentic products relative to counterfeit products.

The graphical user interface 512 is also shown as providing access to additional content relating to the guide bar 104, for example content accessible through hyperlinks provided in the graphical user interface 512. For example, FIG. 5 shows the graphical user interface 512 as including link to order a replacement guide bar, for example a link selectable to navigate to a listing in an online shopping interface to buy a copy of the guide bar 104 and/or to browse a curated selection of compatible guide bars. FIG. 5 also shows the graphical user interface 512 as including a link to information about compatible saw chains, for example selectable to navigate to an online shopping interface showing a curated selection of saw chains compatible with the guide bar 104. In such examples, the communication chip 108 can be understood as guiding a user to facilitate acquisition of compatible replacement parts, thereby enabling maintenance and renewed operations of the chainsaw 100.

As another example, FIG. 5 shows the graphical user interface 512 as including a link to disposal information for the guide bar 104. For example, the guide bar 104 may be suitable for a particular type of metal recycling program, and the graphical user interface 512 may provide information relating to finding such a recycling program near the user's location (e.g., based on location information collected by the smartphone 508) in response to selection of the associated link. The communication chip 108 can thereby contribute to waste diversion away from landfills, promote recycling, etc. to achieve environmental benefits.

As yet another example, FIG. 5 shows the graphical user interface 512 as including a link to frequently asked questions and a link to contact information for a support center for the guide bar 104. The graphical user interface 512 thereby provides access to information that can answer a user's questions relating to the guide bar 104. In various embodiments, various other content relating to the guide bar 104 can be provided via the graphical user interface 512. For example, training information, a user guide, demonstration videos, entertainment content relating to forestry, promotions, customer loyalty program information, etc. can be provided in various embodiments.

The communication chip 108 can be programmable and reprogrammable, for example with information stored thereon updated over the product lifetime. As one example, the communication chip 108 can store updatable fields, flags, etc. which are updated as steps of a manufacturing and/or distribution process are completed to facilitate manufacturing tracking, supply chain management, etc. As another example, the communication chip 108 may provide an editable field accessible to end users, such that end users can add information into the communication chip 108 (e.g., user name, user contact information, user asset tracking number, etc.).

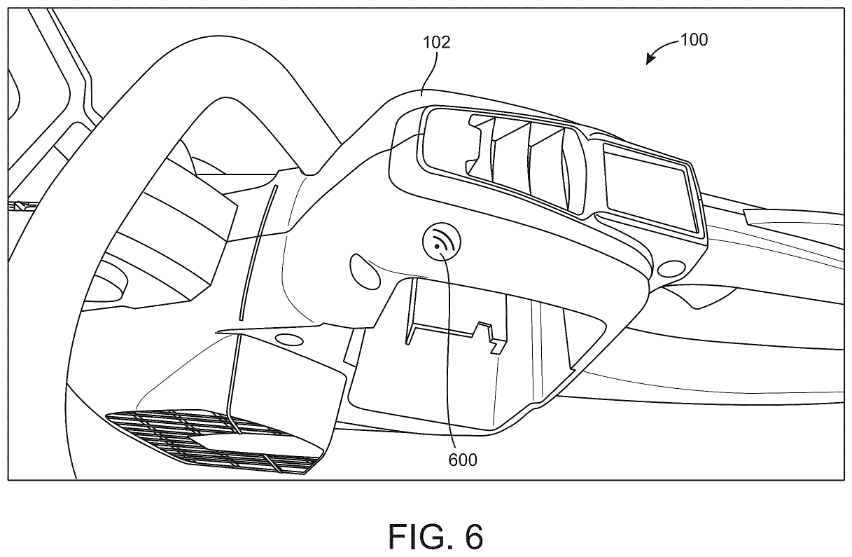

Referring now to FIG. 6, a perspective view of the chainsaw 100 having a communication sticker 600 is shown, according to some embodiments. The communication sticker 600 is shown as affixed to the body 102 of the chainsaw 100. The communication sticker 600 includes a communication chip providing similar functionality as the communication chip 108 described in detail above, including providing access to product information following a process consistent with the illustration 500 of FIG. 5, for example.

In some embodiments, the communication sticker 600 is distributed with the saw chain 106 (or other component or accessory) and is configured to cause a reader device to display information relating to the saw chain 106 (or other component or accessory). Because the saw chain 106 does not have surface area suitable for inclusion of the communication sticker 600 directly thereon, the communication sticker 600 is provided for a user to place on the body 102 of the chainsaw 100. The communication sticker 600 can adhere to the body 102 and remain in place throughout use of the saw chain 106, such that the communication sticker 600 remains accessible at such time as the user is interested in replacing the saw chain 106. The communication sticker 600 can then guide the user (e.g., following a process as described with reference to FIG. 5) to access a compatible replacement saw chain and install said replacement saw chain to enable continued operations of the chainsaw 100.

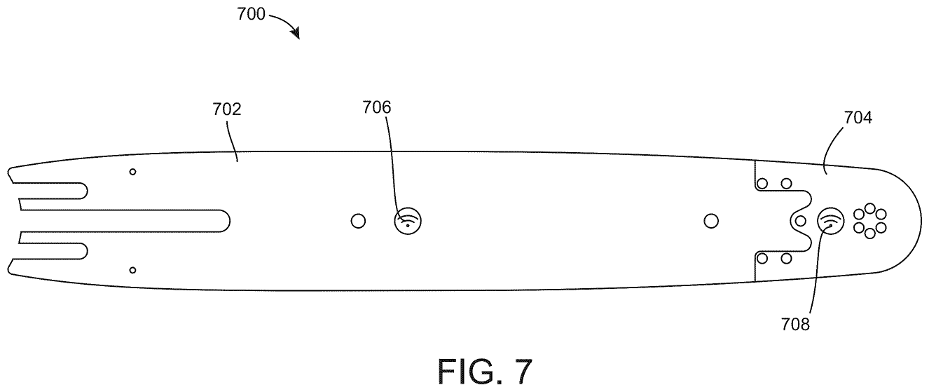

Referring now to FIG. 7, a guide bar 700 is shown, according to some embodiments. The guide bar 700 is a multi-part guide bar, including a body 702 and a nose 704. As arranged in FIG. 7, the nose 704 is coupled to the body 702. The nose 704 is configured to be easily de-coupled from the body 702 such that the body 702 and the nose 704 can be separated. The guide bar 700 of FIG. 7 thereby enables the nose 704 to be removed and replaced (e.g., in response to damage, wear, etc. on the nose 704) without requiring the body 702 to also be discarded and replaced.

As shown in FIG. 7, the guide bar 700 includes a first communication chip 706 positioned on (e.g., coupled to, integrated into, embedded in) the body 702 and a second communication chip 708 positioned on (e.g., coupled to, integrated into, embedded in) the nose 704. In other embodiments, one of the first communication chip 706 or the second communication chip 708 is included and the other is omitted. The first communication chip 706 can provide a message causing a reader device to display information about the body 702, while the second communication chip 708 can provide a message causing a reader device to display information about the nose, for example according to the teachings described in detail above. The teachings herein can thereby facilitate identification, replacement, support, etc. for multiple parts of a multi-part guide bar such as guide bar 700 shown in FIG. 7.

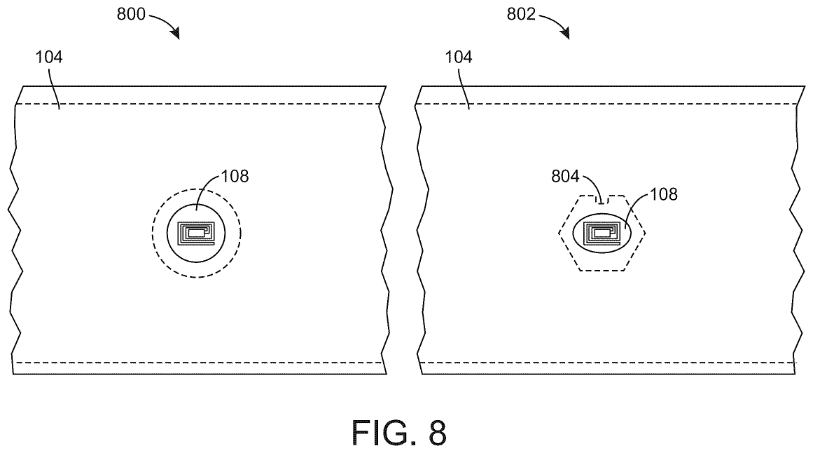

Referring now to FIG. 8, two illustrations of embodiments of the guide bar 104 are shown, according to some embodiments. FIG. 8 illustrates that the communication chip 108 can have various shapes, in various embodiments. In a first illustration 800, the guide bar 104 includes a circular communication chip 108. In a second illustration 802, the guide bar 104 includes a substantially-hexagonal communication chip 108, for example including an indentation 804 ensuring that the communication chip 108 is oriented in a desired orientation in the guide bar 104.

Referring now to FIG. 9, a guide bar 900 is shown, according to some embodiments. The guide bar 900 can include various features as described above for the guide bar 104, in various embodiments. The guide bar 900 is configured to collect data relating to conditions experienced by the guide bar and determine performance characteristics of the guide bar 900, as described in further detail below.

As shown in FIG. 9, the guide bar 900 includes a plate 902 of the guide bar 900, a nose tip 904 coupled to the plate 902 and defining a nose of the guide bar 900, a sprocket 906 included with the nose tip 904, and a mount 910 positioned on the plate 902 at an opposite end of the guide bar 900 as the nose tip 904. The mount 910 is configured to facilitate coupling of the guide bar 900 to the body of a chainsaw 102.

The guide bar 900 is also shown as including onboard circuitry 910 coupled to the plate 902 and arranged so as to not protrude from the plate 902 (e.g., to be flush with a surface of the plate 902). In particular, the plate 902 is shown as including a recess 912 in which a circuit board 914 of the onboard circuitry 910 is positioned and multiple valleys (channels, grooves) extending from the recess 912. The valleys including a first valley 916 extending from the recess 912 and the circuit board 914 to a first corner 918 of the plate 902 (e.g., above the mount 908 from the perspective of FIG. 9), a second valley 920 extending om the recess 912 and the circuit board 914 to a second corner 922 of the plate 902 (e.g., below the mount 908 from the perspective of FIG. 9). The valleys also include a third valley 924 extending upwards (in the perspective of FIG. 9) from the recess 912 to a first side 926 of the plate 902 and a fourth valley 928 extending downwards (in the perspective of FIG. 9) from plate 902 to a second side 930 of the plate 902. The valleys are also shown as including a fifth valley 932 extending forward from the recess 912 and the circuit board 914 to the nose tip 904 (e.g., to the sprocket 906).

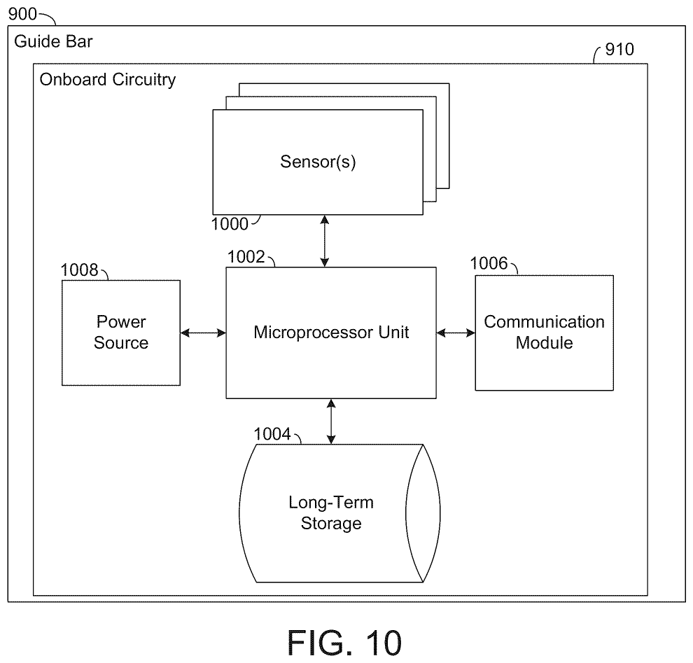

The onboard circuitry 910 can include various sensors, processing, memory, power, and communications components, for example as described in further detail below with reference to FIG. 10. For example, the circuit board 914 can include a power source, a microprocessor, memory, and a communication chip. The circuit board 914 can also include one or more sensor(s), for example an accelerometer or temperature sensor (or any other type of sensor including those described elsewhere herein).

As shown, the onboard circuitry 910 includes sensors positioned in the valleys. A first sensor 934 is positioned in the first valley 916 and proximate the first corner 918, with a wire or other conductive path running along (within) the first valley 916 from the first sensor 934 to the circuit board 914. A second sensor 936 is positioned in the second valley 920 and proximate the second corner 922, with a wire or other conductive path running along the second valley 920 from the second sensor 936 to the circuit board 914. A third sensor 938 is positioned in the third valley 924 and proximate a first side 926 of the plate 902, with a wire or other conductive path running along the third valley 924 from the third sensor 938 to the circuit board 914. A fourth sensor 940 is positioned in the fourth valley 928 and proximate a second side 930 of the plate 902, with a wire or other conductive path running from the fourth sensor 340 to the circuit board 914. A fifth sensor 942 is positioned in the fifth valley 932 proximate the nose tip 904 and sprocket 908, with a wire or other conductive path running from the fifth sensor 942 to the circuit board 914. Any number of additional sensors can be positioned along any of the valleys. In various embodiments, different numbers of valleys, sensors, etc. can be provided. Sensors can thereby be arranged at various positions on the plate 902 and conductively coupled to the circuit board 914 without protruding laterally from the plate 902 (e.g., thereby preventing the sensors, wiring, circuit board, etc. from interfering with performance of the guide bar 900 when in use for cutting).

The circuit board 914 is shown as including a light source 944, for example a light-emitting diode. The light source 944 can be controlled by a microprocessor of the circuit board 914 to illuminate under certain conditions, for example to indicate an event detected by the sensors of the circuit board 914, to indicate a status of communications with the circuit board 914, to indicate a power level of a power source of the circuit board 914, etc.

The circuit board 914 is also shown as including a contact pad 946. The contact pad 946 is configured to provide for communication of electronic signals, data, etc. between the circuit board 914 and an external device. For example, an external computing device (e.g., smartphone, laptop, tablet, desktop computer, virtual reality headset) can be provided with a cable configured to interface with the contact pad 946 to provide communications between the circuit board 914 and the external computing devices. Data can be transferred off of the circuit board 914 to an external computing device via the contact pad. Programming, instructions, commands, machine learning models, pattern recognition algorithms, etc. can be transfer to the circuit board 914 via the contact pad in various embodiments. In some embodiments, a contact pad 946 is additionally or alternatively positioned proximate the mount 908 (e.g., wired to other components along a valley such as the first valley 916) and configured to interface directly with a complementary electronic component on the body 102 of a chainsaw or other equipment used with the guide bar 900.

Referring now to FIG. 10, a block diagram of the guide bar 900 is shown, according to some embodiments. The guide bar 900 includes onboard circuitry 910. The onboard circuitry 910 includes at least one sensor 1000, microprocessor unit 1002, long-term storage 1004, a communication module 1006, and a power source 1008.

The at least one sensor 1000 is configured to measure at least one physical condition of the guide bar 900, for example temperature (bar temperature, ambient temperature), strain, force, motion (acceleration, vibration), proximity (e.g., to external objects, for determining sprocket rotation or chain movement along the guide bar 900), carbon dioxide concentration, barometric pressure, moisture level, light exposure, etc. The at least one sensor 1000 can provide a measurement of the at least one physical sensor to the microprocessor unit 1002.

For example, the at least one sensor 100 can include a temperature sensor, such as a thermistor, a thermocouple, or an infrared thermometer, configured to measure a temperature at the position of the temperature sensor and provide a temperature measurement to the microprocessor unit 1002. Multiple temperature sensors can be arranged on the guide bar 900 such that temperature differentials across the guide bar can be measured. For example, in some embodiments each of the first sensor 934, the second sensor 936, the third sensor 938, and the fourth sensor 940 as shown in FIG. 9 are temperature sensors such that the onboard circuitry 910 can measure temperatures at the first corner 918, second corner 922, first side 926, and second side 930 of the plate 902.

As another example, the at least one sensor 100 can include at least one strain gauge, such as a full bridge, half bridge, or 90 degree rosette strain gauge, configured to provide strain measurements to the microprocessor unit 1002. The strain gauge can measure strain on the guide bar 900, for example strain on the guide bar 900 in one or more directions created by use of the guide bar 900 in a cutting operation. The strain gauge can be provided as part of the circuit board 914 and/or may be positioned along a valley, for example in the fifth valley 932 illustrated in FIG. 9.

As another example, the at least one sensor 100 can include a motion sensor, for example an accelerometer or inertial measurement unit, configured to provide a measurement of movement (e.g., acceleration, vibration, translation, rotation, orientation) of the guide bar 900 to the microprocessor unit 1002. The motion sensor can be included with the circuit board 914 illustrated in FIG. 9.

As another example, the at least one sensor 1000 can include a proximity sensor, such as a Hall effect sensor, an ultrasonic sensor, or a time-of-flight laser sensor (e.g., laser triangulation sensor), configured to provide a proximity measurement to the microprocessor unit 1002. In some embodiments, the fifth sensor 942 is a proximity sensor positioned proximate the sprocket 906 and configured to measure a proximity of the sprocket 906 to the fifth sensor 942. The perimeter of the sprocket is a pattern of teeth extending radially from the sprocket, such that the perimeter of the sprocket will change in distance from the proximity sensor as the sprocket rotates in use. The proximity sensor can detect such distance (or otherwise detect presence of a tooth of the sprocket) to collect data indicative of the speed of rotation of the sprocket. The at least one proximity sensor can thereby be used to measure the speed of the sprocket and, accordingly, the chain speed of a cutting chain engaged by the sprocket.

As another example, the at least one sensor 1000 can measure an environmental conditional of the ambient environment of the guide bar 900 and provide an environmental condition measurement to the microprocessor unit 1002. For example, the at least one sensor 1000 may be a carbon dioxide sensor or carbon monoxide sensor configured to measure the concentration of carbon dioxide or carbon monoxide in the air surrounding the guide bar 900 and provide such a measurement to the microprocessor unit 1002. Various other gases, particulates, etc. can be sensed by the at least one sensor 1000 in various embodiments. The at least one sensor 1000 may measure a barometric pressure at the guide bar 900 and provide the barometric pressure measurement to the microprocessor unit 1002.

As another example, the at least one sensor 1000 can include an imaging or light sensor, such as a camera or photodetector, configured to provide image data to the microprocessor unit 1002. For example, a light sensor can be arranged in the fifth valley 932 can detect when the light sensor is obstructed from receiving ambient light (e.g., daylight), which may be indicative of a cut being executed by the guide bar 900. In some embodiments, a camera is included and provides still images or video of use of the guide bar 900.

Various types of sensors for measuring any physical condition of the guide bar or the ambient environment can be included in at least one sensor 1000 in various embodiments, and the at least one sensor 1000 can include any combination of the different types of sensors disclosed herein in various embodiments.

The microprocessor unit 1002 is configured to receive data from the at least one sensor 1010 and determine at least one performance characteristic based on the data. The at least one performance characteristic can include chain speed, count of cuts made, volume of material cut, chain status (e.g., replacement time, sharpness), bar status (e.g., life remaining, stiffness) events detected, etc. The microprocessor unit 1002 can execute rules-based and/or artificial intelligence (e.g., machine learning) algorithms for determining the performance characteristic(s). The microprocessor unit 1002 can be implemented as various types of processing circuitry in various embodiments.

In some embodiments, the microprocessor unit 1002 executes a rules-based program for determining a performance characteristic based on the sensor data. For example, the microprocessor may compare a sensor measurement to a predefined threshold value (e.g., a measured temperature to a top end of a normal temperature range, an measured acceleration greater than a threshold acceleration, a detected strain greater than a threshold strain) and generate an indication that an event occurred responsive to the sensor measurement exceeding the predefined threshold value. As another example, the microprocessor unit 1002 may include and execute programming for calculating chain speed based on measurement of sprocket rotation by a proximity sensor (e.g., calculating a product based on a measured rate of sprocket rotation and the radius of the sprocket). Such rules can involve different values measured by different sensors (e.g., record that a cutting event occurred if strain and acceleration measurements both satisfy defined conditions). Various examples are possible in various embodiments.

In some embodiments, the microprocessor unit 1002 uses a machine learning (ML) model such as a neural network configured to classify sensor data into categories associated with performance characteristics. For example, an ML model can be configured to receive sensor measurements as inputs, in some embodiments with pre-processing to generate a feature vector from raw sensor data for input to the ML model. The sensor data input to the ML model can be a batch of sensor data over a time period (e.g., a timeseries of acceleration values, a timeseries of strain values, a timeseries of temperature measurements) for one or more measured condition. The ML model can be trained to output, based on such sensor data, an indication of an event represented by the sensor data, e.g., to classify the data as corresponding to a normal cutting event (e.g., an instance of the guide bar 900 used to successfully cut), an adverse cutting event (e.g., an instance of the guide bar 900 used unsuccessfully; an interrupted cut, etc.), a reduced-performance cutting event (e.g., indicating that a chain should be replaced or lubricated, a chainsaw motor lubricated, the guide bar replaced, etc.), an out-of-use time period (e.g., guide bar 900 is not being used to cut, time between cuts, etc.), etc., in various embodiments. The microprocessor unit 1002 can thereby uses the ML model to solve such classification problems based on trends in sensor data.

In some such embodiments, the ML model is trained on a computing system separate from the guide bar, adapted for execution locally at the onboard circuitry 910 of the guide bar, and then provided to the onboard circuitry 910 via the communication module 1006. For example, the ML model may be trained on sets of sensor data which are human-coded with performance characteristics, events, etc. This human-coded data can be used for ML model training using various techniques for supervised model training.

The microprocessor unit 1002 is configured to provide the determined performance characteristics to the long-term storage 1004. The long-term storage 1004 can include one or more memory devices, in various embodiments. The long-term storage 1004 can store a log of the performance characteristics without requiring that raw sensor data also be stored in long-term storage 1004. The long-term storage 1004 can store indications of the performance characteristics and timestamps associated with the point in time at which such performance characteristics occurred. In some embodiments, the microprocessor discards the raw sensor data following determination of a performance condition stored thereon, thereby reducing memory requirements and power demand which may otherwise be associated with long-term storage of all raw sensor data. In some embodiments, at least a subset of the raw sensor data is stored in long-term storage (e.g., in response to detection of an event of interest).

The communication module 1006 is configured to facilitate communications between the microprocessor unit 1002 and an external computing device. The communication module 1006 can provide for wireless communications (e.g., via near-field communication, Bluetooth, WiFi, etc.) and/or wired communications (e.g., via contact pad 946). The communication module 1006 can include various network circuitry (antenna, transceiver, etc.) and processing capabilities for providing and receiving data via various communications protocols. The communication module 1006 enables the log of performance characteristics stored in long-term storage 1004 to be communicated from the onboard circuitry 910 to an external computing device for presentation to a user. The communication module 1006 also enables information to be communicated from an external computing device to the onboard circuitry 910, for example one or more models or algorithms to be used by the microprocessor unit 1002, user inputs (commands, settings, etc.), or other information, data, or programming.

The power source 1008 is configured to provide power (electricity, voltage, current, etc.) for the microprocessor unit 1002, long-term storage 1004, communication module 1006, and sensor(s) 1000. The power source 1008 can include a battery, for example a battery rechargeable via input power received from an external source (e.g., via contact pad 946). The power source 1008 can include a generator device, for example a vibration-powered generator such as a piezoelectric generator, configured to generate electricity from kinetic energy experienced by the power source 1008 during use of the guide bar 900. In some embodiments, the power source 1008 includes a connection to the body 102 of the chainsaw 100 or other equipment used with the guide bar 900 in order to receive power from such equipment.

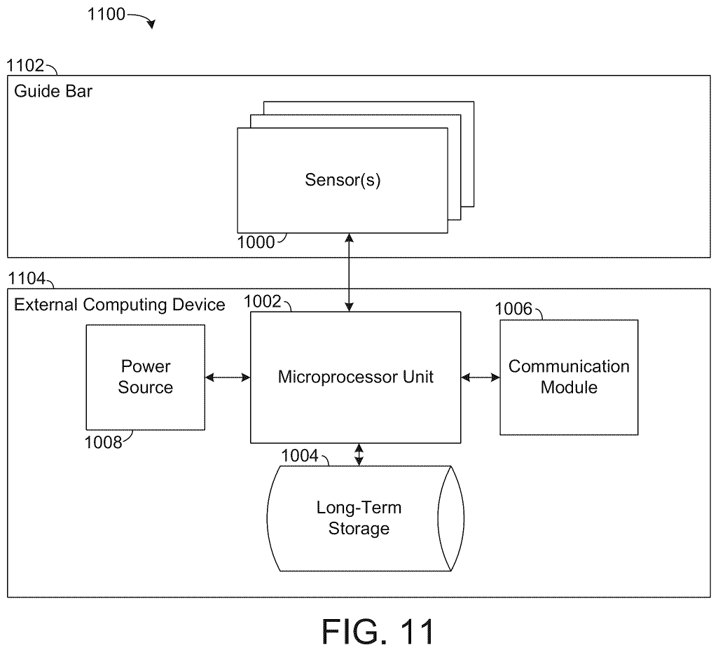

Referring now to FIG. 11, a block diagram of a system 1100 including a guide bar 1102 and an external computing device 1104 is shown, according to some embodiments. As shown in FIG. 11, the guide bar 1102 includes the at least one sensor 1000 while the external computing device 1104 includes the microprocessor unit 1002, the long-term storage 1004, the communication module 1006, and the power source 1008. In such embodiments, sensor(s) 1000 remain are embedded in, onboard, etc. the guide bar 1102 while other components are located in an external computing device 1104. The external computing device 1104 can be coupled to, positioned in, positioned on, etc. the body 102 of the chainsaw 100 shown in FIG. 1 and/or otherwise provided as an element of equipment used with the guide bar 1102. The sensor(s) 1000 can provide data to the microprocessor unit 1002 via a conductive path between the guide bar 1102 and the external computing device 1104 (e.g., input/output ports, contact pad, etc. on the guide bar 1102, with wiring to the external computing device 1104; wireless communication). The external computing device 1104 and the guide bar 1102 can combine in such embodiments to provide substantially the same features as described above for the onboard circuitry 910 with reference to FIG. 10. Generally referring to the figures, the teachings herein can be adapted for other components of equipment, for example other forestry, landscaping, or agricultural equipment. For example a mower blade (e.g., for a lawn mower, for a rotary cutter) may have a communication chip and/or other onboard circuitry installed in a recess therein, according to the teachings herein.

Teachings herein relate to an electronic data collection system embedded in a saw chain bar, including one or more of: an external indicator that declares status (for example a light source), one or more sensors to measure states of the system, a processor configured to execute one or more software operations on the sensor data, a memory for storing data associated with said software operations, and a wired or wireless communication module for external connectivity. The processor can include machine learning logic configured to apply a trained model to sensor data configured to make judgments, classifications, etc. relating to the sensor data. Teachings herein relate to a method for operating an electronic data collection system embedded in a saw chain bar. The method includes receiving physical input through onboard and integrated sensors, executing software operations associated with the physical input and further based on an event, machine input, machine learning operations, and/or user input; storing data associated the executed software operations in solid-state memory, and transceiving data using a wired or wireless communication module.

Teachings herein also relate to an electronic data collection system capable of processing sensor data from sensors embedded in a bar. The system includes a device separate from the bar but built as a dedicated device for processing data from sensors embedded in the bar. The device can provide processing including signal conditioning, data storing, machine learning, classification using a machine-learnt algorithm, etc., where processing and communications are provided external to the bar.

Teachings herein also relate to a chain saw including a guide bar including a recess and a communication chip positioned in the recess of the guide bar. The communication chip is configured to cause a reader device to display information relating to the guide bar.

A guide bar can include a first layer including a recess and a communication chip positioned in the recess. The communication chip can be configured to store a message relating to the guide bar and transmit the message in response to induction of a current in the communication chip. In some embodiments, the guide bar includes a second layer coupled to the first layer, with the communication chip mechanically held in the recess by the first layer and the second layer.

In some embodiments, the guide bar also includes a second layer coupled to the first layer, with the second layer including a window aligned with the recess and the communication chip. The window is configured to allow transmission of electronic communications across the second layer. The guide bar can also include a third layer coupled to the first layer such that the first layer is between the second layer and the third layer. The first layer, the second layer, and the third layer can be made at least partially of steel.

The guide bar can include an adhesive holding the communication chip in the recess. The communication chip may be a passive near-field communication tag. The message may be an address for a website including content relating to the guide bar.

Teachings herein also relate to a method of replacing a guide bar on a chain saw. The method includes obtaining an electronic message from a passive communication chip embedded in the guide bar by bringing a reader device into proximity with the passive communication chip, acquiring a replacement guide bar based on the electronic message, and installing the replacement guide bar on the chain saw. The method can include providing, by the reader device, a graphical user interface based on the electronic message, the graphical user interface configured to allow a user to order the replacement guide bar.

The present disclosure also relates to a kit for use with a chainsaw, including a cutting chain and a sticker including a communication chip. The sticker is configured to be adhered to the chainsaw, and the communication chip is configured to cause a reader device to display information relating to the cutting chain.

The present disclosure also relates to forestry, landscaping, or agricultural equipment including a replaceable component configured to interact with environmental objects during operation of the equipment, and a communication chip integrated into the replaceable component, wherein the communication chip is configured to cause a reader device to display information relating to the replaceable component.

Referring generally to the disclosure herein, although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The hardware and data processing components used to implement the various processes, operations, illustrative logics, circuits, etc. described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

What is claimed is:

1. A guide bar, comprising:
a first layer comprising a recess; and
a communication chip positioned in the recess, wherein the communication chip is configured to:
store a message relating to the guide bar; and
transmit the message in response to induction of a current in the communication chip.

2. The guide bar of claim 1, further comprising a second layer coupled to the first layer, wherein the communication chip is mechanically held in the recess by the first layer and the second layer.

3. The guide bar of claim 1, further comprising a second layer coupled to the first layer, wherein the second layer comprises a window aligned with the recess and the communication chip, wherein the window is configured to allow transmission of electronic communications across the second layer.

4. The guide bar of claim 3, further comprising a third layer coupled to the first layer such that the first layer is between the second layer and the third layer, wherein the first layer, the second layer, and the third layer comprise steel.

5. The guide bar of claim 1, further comprising an adhesive holding the communication chip in the recess.

6. The guide bar of claim 1, wherein the communication chip is a passive near-field communication tag.

7. The guide bar of claim 1, wherein the message is an address for a website comprising content relating to the guide bar.

8. A guide bar for a chainsaw, comprising:
a plate comprising a channel and a recess;
a sensor positioned in the channel;
processing circuitry positioned in the recess and configured to receive measurements from the sensor;
wherein the processing circuitry is programmed to determine a performance characteristic of the guide bar based on the measurements from the sensor.

9. The guide bar of claim 8, wherein the processing circuitry is programmed to determine the performance characteristic by applying the measurements as inputs to a machine learning model, wherein the machine learning model is configured to output the performance characteristic.

10. The guide bar of claim 8, wherein the sensor is a temperature sensor.

11. The guide bar of claim 8, wherein the sensor is a strain gauge.

12. The guide bar of claim 8, wherein the measurement is indicative of a chain speed.

13. The guide bar of claim 8, further comprising a plurality of additional channels extending from the recess and a plurality of additional sensors positioned in the plurality of additional channels.

14. The guide bar of claim 8, further comprising a motion sensor positioned in the recess.

15. The guide bar of claim 8, further comprising a power source configured to generate electricity from vibration of the guide bar and provide the electricity to the processing circuitry.

16. A method, comprising:
collecting, by a sensor embedded in a chainsaw bar, sensor data indicative of a physical condition relating to the chainsaw bar;
determining, by a microprocessor unit embedded in the chainsaw bar, occurrence of an event based on the sensor data;
storing, in memory embedded in the chainsaw bar, a log indicating the occurrence of the event while discarding the sensor data.

17. The method of claim 16, further comprising communicating, by communication circuitry embedded in the chainsaw bar, the log to an external computing device.

18. The method of claim 16, further comprising illuminating, by a light source coupled to the microprocessor unit, in response to the event.

19. The method of claim 16, comprising communicating the sensor data from the sensor to the microprocessor unit via a valley defined in a plate of the chainsaw bar.

20. The method of claim 16, wherein determining, by the microprocessor unit embedded in the chainsaw bar, occurrence of the event based on the sensor data comprises applying a machine learning model to the sensor data.
